(19) United States
(12) Patent Application Publication
(10) Pub. No.: US 2003/0092809 A1
(43) Pub. Date: May 15, 2003

(54) Removable coating for optical substrates

(76) Inventors: Fang Chen, South Australia (AU); Arambally Natiala Sunder Ram, Petaluma, CA (US)

Correspondence Address: BURNS DOANE SWECKER & MATHIS L L P, POST OFFICE BOX 1404, ALEXANDRIA, VA, 22313-1404, US

(21) Appl. No.: 10/239,071

(22) PCT Filed: Mar. 23, 2001
(86) PCT No.: PCT/AU01/00327

(30) Foreign Application Priority Data
Mar. 23, 2000 (AU) PQ 6419

(51) Int. Cl. C08K 5/09

(52) U.S. Cl. 524/291; 524/313; 524/557; 524/567; 524/569; 524/566; 524/571; 524/575; 524/377; 524/387; 524/320; 524/322; 524/296; 524/297; 524/311; 524/314

(57) ABSTRACT

The present invention provides a composition for forming a removable coating for an optical substrate. In this form, the composition is an aquesous emulsion having one or more substantially non-polar polymers.

### FIELD OF THE INVENTION

The present invention relates to compositions suitable to form removable coatings on optical substrates, together with methods of forming such removable coatings on optical substrates. The present invention also relates to optical substrates having such removable coatings thereon.

It will become apparent from the following description that the optical substrates are most likely to be optical articles such as ophthalmic lenses or lens blanks. However, it must be appreciated that the invention is not to be limited in its application to only those optical substrates.

### BACKGROUND OF THE INVENTION

Optical substrates in the form of optical articles, such as ophthalmic lenses, may be laminate structures formed by the bonding together of two or more lens wafers. A significant problem in the formation of such ophthalmic lenses is that exogenous materials such as dust, dirt, manufacturing residue, fingerprints and moisture may contaminate the surfaces of the wafers prior to them being bonded. Also, the surfaces of the lens wafers may be damaged (such as during manufacture, packaging or transport) prior to them being bonded.

For these reasons various temporary, protective coatings have been employed to protect the surfaces of lens wafers prior to bonding and as an alternative means of packaging.

A number of different compositions have been used for forming prior art protective coatings for the surfaces of ophthalmic lenses. However, a deficiency in the prior art has been the unsuitability of these compositions for forming removable coatings for ophthalmic lenses made from materials such as polycarbonate, which materials are easily damaged by (for example) certain solvents that may be desirably present in the removable coatings themselves or that may be desirable for use in compounds used to remove the coatings.

For example, coating compositions based on polymeric materials dissolved in organic solvents such as acetone have been described in the prior art for use in forming coatings on ophthalmic lenses. However, the use of acetone-based solvents in the composition restricts the type of lens substrates to which the coating can be applied. For instance, polycarbonate substrates will be eroded by acetone solvents, rendering these coating compositions unsuitable for use on polycarbonate ophthalmic lenses.

Compositions based on aqueous solutions of polymeric materials have also been employed for the production of removable coatings, but these coatings have generally still contained organic compounds, such as plasticizers or coalescent agents, that have typically resulted in coatings that require organic solvents for their removal or have resulted in coatings that are not readily removable from the surfaces of some substrates, again such as polycarbonate substrates.

Therefore, a deficiency in the prior art has been the inability to formulate a composition suitable for forming removable coatings on a variety of optical substrates, including those substrates made of polycarbonate, and it is an object of the present invention to overcome that deficiency.

### SUMMARY OF THE INVENTION

The present invention provides a composition for forming a removable coating for an optical substrate, the composition being an aqueous emulsion having one or more substantially non-polar polymers. The use of an appropriate substantially non-polar polymer, or a mixture of such appropriate polymers, which is able to form an aqueous emulsion avoids the need to use potentially damaging organic solvents, such as acetone, in the composition of the invention.

Without being bound by theory, it is likely that compositions formed from substantially non-polar polymers do not adhere very strongly to optical substrates because of the lower intermolecular association between molecules in the coating and molecules in the material of the optical substrate. Polar polymer compositions, such as those formed from acrylic acid and its derivatives, appear not to form readily removable coatings due to the strength of adhesion between the coating and the optical substrate.

The term “removable coating” as used in the specification is to be understood to mean any coating that may be removed from the surface of the substrate by physical separation of the coating from the substrate. For example, the physical separation may be accomplished by peeling the coating by hand from the surface of the substrate.

The term “optical substrate” as used in the specification is to be understood to mean any substrate that functions to transmit or reflect light. The term includes optical articles such as ophthalmic lenses, and any other optical article that may require a protective coating during its manufacture, storage, transport or use.

The term “polymer” as used in the specification is to be understood to mean substances that are either homopolymers, which are formed from monomeric units of a single type, or copolymers, which are formed from two or more different types of monomeric units. Further, the term “substantially non-polar polymer” is to be understood to mean a polymer, or a mixture of polymers, that exhibits a low intermolecular attraction for the optical substrate such that the coating may be readily removed therefrom.

The composition according to the present invention is preferably made from one or more polymers chosen from the group consisting of vinyl acetate-ethylene copolymers, polyvinyl chloride polymers, ethylene-vinyl chloride copolymers, polyvinyl acetate polymers, polyvinyl butyral polymers, styrene-butadiene copolymers, and acrylonitrile-butadiene copolymers.

In a preferred form of the present invention, an appropriate polymer, or a mixture of appropriate polymers, may be selected for use in the aqueous emulsion with reference to a particular polymer parameter. Indeed, the present inventors have recognised that a relevant consideration for the formulation of compositions suitable for the formation of removable coatings using aqueous emulsions of polymers is the glass transition temperature (T_{g}) of the coating formed from the polymer, or where there is a mixture of polymers, the glass transition temperature of the coating formed from the mixture. The glass transition temperature of the coating is that temperature at which a polymer undergoes a transition from a hard and rigid state (ie glassy) to a soft and flexible state (ie rubbery). In this respect, it is to be understood that selection of the appropriate glass transition temperature assists in the formulation of aqueous emulsions with properties desirable for the formation of removable coatings.

As will be appreciated by someone skilled in the art, the glass transition temperature of the coating may be determined by using the technique of differential scanning calorimetry.

In this respect, the inventors have determined that coatings derived from aqueous emulsions of polymers (or mixtures of polymers) with an unacceptably low glass transition temperature tend to be very flexible, but have very strong (and thus undesirable) adhesion properties. To the contrary, coatings derived from aqueous emulsions of polymers having an unacceptably high glass transition temperature tend to be very brittle and are therefore unsuitable as a removable coating.

Also, the glass transition temperature is related to the minimum film forming temperature (MFFT). The MFFT is the minimum temperature at which an emulsion will coalesce to form a film or coating, as occurs during drying. The MFFT is usually close to the glass transition temperature. Accordingly, if the MFFT is above ambient temperature, a coating will not form at ambient temperature and the drying temperature must be increased before a coating will form. Indeed, drying of an emulsion laid on a substrate above the MFFT allows the particles in the emulsion to coalesce into a smooth film on the substrate surface, whereas drying of an emulsion below the MFFT does not allow the particles to coalesce into a smooth film, resulting in a powdery and cracked coating. Thus, it may be necessary to control and/or adjust the temperature at which the emulsion is dried in order to form coatings according to the present invention.

Therefore, in a preferred form of the present invention, the composition is preferably an aqueous emulsion having one or more substantially non-polar polymers that form a coating with a glass transition temperature in the range from −5° C. to 40° C. Preferably, the composition may be an aqueous emulsion having one or more substantially non-polar polymers that form a coating with a glass transition temperature in the range from 0° C. to 35° C. More preferably, the composition may be an aqueous emulsion having one or more substantially non-polar polymers that form a coating with a glass transition temperature in the range from 5° C. to 30° C.

Substantially non-polar polymers able to form a coating having a glass transition temperature in the preferred range can be used, or alternatively a formulation that will provide a coating with a glass transition temperature in the preferred range can be obtained by mixing an amount of an appropriate polymer having a lower glass transition temperature with an appropriate polymer having a higher glass transition temperature.

For example, a vinyl acetate-ethylene emulsion with a low glass transition temperature may be combined with an ethylene-vinyl chloride copolymer emulsion with a higher glass transition temperature, to produce an emulsion that will form a coating with a glass transition temperature suitable for the present invention.

Plasticizers may or may not be added depending on the characteristics of the emulsions to be used. Plasticisers may be employed to improve the flexibility of the coating. Suitable plasticisers include triethyl citrate, di-butyl phthalate and dipropylene glycol dibenzoate.

The plasticisers may constitute up to 15% by weight of the composition according to the present invention. However, as the plasticisers suitable for the present invention are likely to be small organic molecules, the amount of plasticiser suitable for polycarbonate lenses will be such that the lens is not damaged by the amount of plasticiser present in the composition. Additionally, as these small molecules are likely to increase the adhesion between the coating and polycarbonate substrates, the amount of plasticiser present in the composition should be such that the level of adhesion does not affect the ability to remove the coating from the substrate.

It may also be desirable to add one or more antistatic agents. The addition of antistatic agents is particularly beneficial to prevent the accumulation of a static charge on the surface of the substrate when the coating is removed, which may result in the attraction of dust and other contaminating particles to the surface of the substrate.

Antistatic agents may be added in an amount in the range of 0.1 to 5.0% by weight. The antistatic agents may be selected from the group consisting of polyhydroxy derivatives of glycerine, polyhydroxy derivatives of sugars, polyhydroxy derivatives of fatty acids, alkylpolyglycol ethers, alkylphenol polyglycol ethers and polyglycol ethers obtained from the reaction of glycols and oxiranes. A preferred antistatic agent is Gylcolube AFA-1 (available from Lonza).

Dyes may also be added to the compositions according to the present invention, depending on the final visual characteristics required for the coatings. Suitable dyes include FD&C Blue No. 1, FD&C Red No. 40, FD&C Green No. 3 or FD&C Yellow No. 6.

Further, the present invention is directed to a method for forming a removable coating on an optical substrate, the method including:

(a) applying to the substrate a composition including an aqueous emulsion of one or more substantially non-polar polymers; and

(b) drying the applied composition so as to form a coating on the substrate.

The composition according to the present invention may be preferably applied to the substrate by spin coating, but other methods of applying the coating to the substrate also include dip coating, spray coating and brushing.

### DESCRIPTION OF PREFERRED EMBODIMENTS

The present invention will now be described in relation to various examples of preferred embodiments. However, it must be appreciated that the following description is not to limit the generality of the above description.

### EXAMPLE 1

60 g of an aqueous vinyl acetate-ethylene polymer emulsion (available under the trade name Airflex 510 from Air Products; solid content 55%; Tg=6° C.) was mixed with 40 g of an aqueous ethylene-vinyl chloride copolymer emulsion (available under the trade name Airflex 4530 from Air Products; solid content 50%; Tg=29° C.) and stirred for 10 minutes. 0.8 g of plasticizer triethyl citrate and 0.8 g of antistatic agent Glycolube AFA-1 (from Lonza) were added with stirring. The final emulsion was stirred slowly for one hour and filtered through glass wool. The emulsion was left standing for ten minutes prior to coating on suitable ophthalmic lenses for the purposes of evaluation. Throughout the procedure, evaporation was minimised. The viscosity of the emulsion was 195 cps at 20° C. Spin coating was performed at 650 rpm and the final coating thickness on the ophthalmic lenses was approximately 25 μm. Spin coating and the subsequent drying of the coating were both performed at a temperature above the MFFT. The coating was tack-free after 5 minutes of spinning at room temperature. Excess aggregated polymer was removed from the edges of the article. The coating was fully dried after 18 hours at room temperature.

The glass transition temperature of the coating formed from the above formulation was determined to be 12° C. by differential scanning calorimetry using a heating rate of 20° C./minute.

The coating was removed by the application of adhesive paper thereto, and by then peeling the coating from bare and hard coated polycarbonate, and bare and hard coated CR39, SPECTRALITE and FINALITE lenses. Upon removal of the coating, no visible residue was evident. Dust, fingerprints and other exogenous material were removed, and there was no evidence of any erosion of the substrates. (SPECTRALITE and FINALITE are trade marks of Sola International Inc. CR39 is a trade mark of PPG Industries Inc).

### EXAMPLE 2

85 g of an aqueous styrene butadiene copolymer emulsion (available under the trade name Rovene 4041 from American Synpol; solid content 50%; Tg=17° C.) was mixed with 15 g aqueous styrene butadiene copolymer emulsion (available under the trade name Rovene 4106 from American Synpol; solid content 50%; Tg=69° C.) with stirring for 30 minutes. The final emulsion was filtered through glass wool, and then left standing for ten minutes prior to coating on suitable ophthalmic lenses. Throughout the procedure, evaporation was minimised.

Spin coating was performed at 550 rpm and the final coating thickness was approximately 20 to 30 μm. Spin coating and the subsequent drying of the coating were both performed at a temperature above the MFFT. The coating was tack-free after 6 minutes of spinning. Excess aggregated polymer was removed from the edges of the article. The coating was fully dried after 18 hours.

The glass transition temperature of the coating formed from the above formulation was determined to be 25° C. by differential scanning calorimetry using a heating rate of 20° C./minute.

The coating was again removed by the application of adhesive paper thereto, and by then peeling the coating from bare and hard coated polycarbonate, and bare and hard coated CR39, SPECTRALITE and FINALITE lenses. Upon removal of the coating no visible residue was evident, and dust, fingerprints and other exogenous material were removed. There was no evidence of erosion of the lens substrates.

### EXAMPLE 3

To 100 g of an aqueous ethylene-vinyl chloride copolymer emulsion polymer (available under the trade name Airflex 4514 from Air Products; solid content 50%; Tg=12° C.) was added 1 g of antistatic agent Glycolube AFA-1 (from Lonza) with stirring. The emulsion was stirred slowly for thirty minutes prior to coating.

Spin coating was performed at 550 rpm and the final coating thickness on the ophthalmic lenses was approximately 20 to 30 μm. Spin coating and the subsequent drying of the coating were both performed at a temperature above the MFFT. The coating was tack-free after 6 minutes of spinning at room temperature. The coating was fully dried after 18 hours at room temperature.

The glass transition temperature of the coating formed from the above formulation was determined to be approximately 12° C. by differential scanning calorimetry using a heating rate of 20° C./minute.

The coating so formed was clear and colourless and did not effect through power checking with a Humphrey Vertometer.

The coating was removed by the application of adhesive paper thereto, and by then peeling the coating from bare polycarbonate, and bare and hard coated CR39, SPECTRALITE and FINALITE lenses. Upon removal of the coating, no visible residue was evident. Dust, fingerprints and other exogenous material were removed, and there was no evidence of any erosion of the substrates.

### EXAMPLE 4

80 g of an aqueous styrene butadiene copolymer emulsion (available under the trade name Rovene 4041 from American Synpol; Tg=17° C.) was mixed with 20 g of an aqueous styrene butadiene copolymer emulsion (available under the trade name Rovene 4106 from American Synpol; Tg=69° C.). 0.8 g of antistatic agent Glycolube AFA-1 (from Lonza) was added with stirring. The emulsion was stirred slowly for thirty minutes prior to coating.

Spin coating was performed at 550 rpm and the final coating thickness on the ophthalmic lenses was approximately 20 to 30 μm. Spin coating and the subsequent drying of the coating were both performed at a temperature above the MFFT. The coating was tack-free after 6 minutes of spinning. The coating was fully dried after 18 hours.

The glass transition temperature of the coating formed from the above formulation was determined to be 26° C. by differential scanning calorimetry using a heating rate of 20° C./minute.

The coating so formed was clear and colourless and did not effect through power checking with a Humphrey Vertometer.

The coating was removed by the application of adhesive paper thereto, and by then peeling the coating from bare polycarbonate, and bare and hard coated CR39, SPECTRALITE and FINALITE lenses. Upon removal of the coating, no visible residue was evident. Dust, fingerprints and other exogenous material were removed, and there was no evidence of any erosion of the substrates.

### EXAMPLE 5

75 g of an aqueous styrene butadiene copolymer emulsion (available under the trade name Rovene 4041 from American Synpol; Tg=17° C.) was mixed with 25 g of an aqueous styrene butadiene copolymer emulsion (available under the trade name Rovene 4106 from American Synpol; Tg=69° C.). 0.8 g of antistatic agent Glycolube AFA-1 (from Lonza) was added with stirring. The emulsion was stirred slowly for thirty minutes prior to coating.

Spin coating was performed at 550 rpm and the final coating thickness on the ophthalmic lenses was approximately 20 to 30 μm. Spin coating and the subsequent drying of the coating were both performed at a temperature above the MFFT. The coating was tack-free after 6 minutes. The coating was fully dried after 18 hours.

The glass transition temperature of the coating formed from the above formulation was determined to be 28° C. by differential scanning calorimetry using a heating rate of 20° C./minute.

The coating so formed was clear and colourless and did not effect through power checking with a Humphrey Vertometer.

The coating was removed by the application of adhesive paper thereto, and by then peeling the coating from bare polycarbonate, and bare and hard coated CR39, SPECTRALITE and FINALITE lenses. Upon removal of the coating, no visible residue was evident. Dust, fingerprints and other exogenous material were removed, and there was no evidence of any erosion of the substrates.

### EXAMPLE 6

65 g of an aqueous styrene butadiene copolymer emulsion (available under the trade name Rovene 4100 from American Synpol; Tg=−5° C.) was mixed with 35 g of an aqueous styrene butadiene copolymer emulsion (available under the trade name Rovene 4106 from American Synpol; Tg=69° C.). The emulsion was stirred slowly for thirty minutes prior to coating.

Spin coating was performed at 550 rpm and the final coating thickness on the ophthalmic lenses was approximately 20 to 30 μm. Spin coating and the subsequent drying of the coating were both performed at a temperature above the MFFT. The coating was tack-free after 6 minutes of spinning at room temperature. The coating was fully dried after 18 hours at room temperature.

The glass transition temperature of the coating formed from the above formulation was determined to be 16° C. by differential scanning calorimetry using a heating rate of 20° C./minute.

The coating so formed was clear and colourless and did not effect through power checking with a Humphrey Vertometer.

The coating was removed by the application of adhesive paper thereto, and by then peeling the coating from bare polycarbonate, and bare and hard coated CR39, SPECTRALITE and FINALITE lenses. Upon removal of the coating, no visible residue was evident. Dust, fingerprints and other exogenous material were removed, and there was no evidence of any erosion of the substrates.

### EXAMPLE 7

64 g of an aqueous vinyl acetate-ethylene emulsion polymer (available under the trade name Airflex 510 from Air products) was mixed with 36 g of an aqueous vinyl copolymer emulsion (available under the trade name Ucar AW 875 from Union Carbide). The emulsion was stirred slowly for thirty minutes prior to coating. The emulsion had a viscosity of 342 cps at 20° C. Spin coating was performed at 900 rpm and the final coating thickness on the ophthalmic lenses was approximately 20 to 30 μm. Spin coating and the subsequent drying of the coating were both performed at a temperature above the MFFT. The coating was tack-free after 5 minutes of spinning. After 1 hour the coating would not adhere to other material. The coating was fully dried after 18 hours.

The glass transition temperature of the coating formed from the above formulation was determined to be 28° C. by differential scanning calorimetry using a heating rate of 20° C./minute.

The coating was removed by the application of adhesive paper thereto, and by then peeling the coating from bare polycarbonate, and bare and hard coated CR39, SPECTRALITE and FINALITE lenses. The coating was not suitable for removable by peeling from bare polycarbonate, but was suitable for peeling from bare and hard coated CR39, SPECTRALITE and FINALITE lenses.

### EXAMPLE 8

To 91 g of an aqueous vinyl copolymer emulsion polymer (available under the trade name Ucar AW 875 from Union Carbide) was added dropwise 9 g of plasticiser triethyl citrate (from Morflex) with stirring. The emulsion was stirred for 30 minutes prior to coating.

Spin coating was performed at 900 rpm and the final coating thickness on the ophthalmic lenses was approximately 20 to 30 μm. Spin coating and the subsequent drying of the coating were both performed at a temperature above the MFFT. The coating was tack-free after 5 minutes of spinning at room temperature. After 1 hour of standing at room temperature the coating would not adhere to other material. The coating was fully dried after 18 hours at room temperature. The resultant coating was strong and clear.

The glass transition temperature of the coating formed from the above formulation was determined to be 15° C. by differential scanning calorimetry using a heating rate of 20° C./minute.

The coating was removed by the application of adhesive paper thereto, and by then peeling the coating from bare polycarbonate, and bare and hard coated CR39, SPECTRALITE and FINALITE lenses. The coating was not suitable for removable by peeling from bare polycarbonate, but was suitable for peeling from bare and hard coated CR39, SPECTRALITE and FINALITE lenses.

### EXAMPLE 9

To 90 g of an aqueous ethylene-vinyl chloride copolymer emulsion polymer (available under the trade name Airflex 4530 from Air Products) was added dropwise 10 g of plasticiser di-butyl phthalate (from Aldrich) with stirring. The emulsion was stirred for 30 minutes prior to coating.

Spin coating was performed at 900 rpm and the final coating thickness on the ophthalmic lenses was approximately 20 to 30 μm. Spin coating and the subsequent drying of the coating were both performed at a temperature above the MFFT. The coating was tack-free after 5 minutes of spinning at room temperature. The coating was fully dried after 18 hours at room temperature. The resultant coating was strong and clear.

The glass transition temperature of the coating formed from the above formulation was determined to be 10° C. by differential scanning calorimetry using a heating rate of 20° C./minute.

The coating was removed by the application of adhesive paper thereto, and by then peeling the coating from bare polycarbonate, and bare and hard coated CR39, SPECTRALITE and FINALITE lenses. The coating was not suitable for removable by peeling from bare polycarbonate, but was suitable for peeling from bare and hard coated CR39, SPECTRALITE and FINALITE lenses.

Finally, it will be appreciated that there may be other modifications and alterations made to the compositions and formulations described above that are also within the scope of the present invention.

The claims defining the invention are as follows:

1. A composition for forming a removable coating for an optical substrate, the composition being an aqueous emulsion having one or more substantially non-polar polymers.

2. A composition according to claim 1, wherein the coating formed from said aqueous emulsion has a glass transition temperature in the range from −5° C. to 40° C.

3. A composition according to claim 1, wherein the coating formed from said aqueous emulsion has a glass transition temperature in the range from 0° C. to 35° C.

4. A composition according to claim 1, wherein the coating formed from said aqueous emulsion has a glass transition temperature in the range from 5° C. to 30° C.

5. A composition according to any one of claims 1 to 4, wherein the non-polar polymers are selected from the group consisting of vinyl acetate-ethylene copolymers, polyvinyl chloride polymers, ethylene-vinyl chloride copolymers, polyvinyl acetate polymers, polyvinyl butyral polymers, styrene-butadiene copolymers, and acrylonitrile-butadiene copolymers.

6. A composition according to any one of claims 1 to 5, wherein the composition includes an antistatic agent.

7. A composition according to claim 6, wherein the antistatic agent is selected from the group consisting of polyhydroxy derivatives of glycerine, polyhydroxy derivatives of sugars, polyhydroxy derivatives of fatty acids, alkylpolyglycol ethers, alkylphenol polyglycol ethers and polyglycol ethers obtained from the reaction of glycols and oxiranes.

8. A composition according to claim 7, wherein the antistatic agent is Glycolube AFA-1.

9. A composition according to any one of claims 6 to 8, wherein the composition includes from 0.1% to 5% by weight of antistatic agent.

10. A composition according to any one of claims 1 to 9, wherein the composition includes a plasticizer.

11. A composition according to claim 10, wherein the plasticiser is selected from the group consisting of triethyl citrate, di-butyl phthalate and dipropylene glycol dibenzoate.

12. A composition according to claim 10 or 11, wherein the composition includes from 0.1% to 15% by weight of plasticiser.

13. A composition according to any one of claims 1 to 12, wherein the composition includes a dye.

14. A composition according to claim 13, wherein the dye is selected from the group consisting of FD&C Blue No. 1, FD&C Red No. 40, FD&C Green No. 3 and FD&C Yellow No. 6.

15. A method for forming a removable coating on an optical substrate, said method including:
(a) applying to the substrate a composition including an aqueous emulsion of one or more substantially non-polar polymers; and
(b) drying the applied composition so as to form a coating on the substrate.

16. A method according to claim 15, wherein the coating formed has a glass transition temperature in the range from −5° C. to 40° C.

17. A method according to claim 15, wherein the coating formed has a glass transition temperature in the range from 0° C. to 35° C.

18. A method according to claim 15, wherein the coating formed has a glass transition temperature in the range from 5° C. to 30° C.

19. A method according to any one of claims 15 to 18, wherein said non-polar polymers are selected from the group consisting of vinyl acetate-ethylene copolymers, polyvinyl chloride polymers, ethylene-vinyl chloride copolymers, polyvinyl acetate polymers, polyvinyl butyral polymers, styrene-butadiene copolymers, and acrylonitrile-butadiene copolymers.

20. A method according to any one of claims 15 to 19, wherein said composition includes an antistatic agent.

21. A method according to claim 20, wherein the antistatic agent is selected from the group consisting of polyhydroxy derivatives of glycerine, sugar and fatty acids, alkylpolyglycol ethers, alkylphenol polyglycol ethers and polyglycol ethers obtained from the reaction of glycols and oxiranes.

22. A method according to claim 21, wherein the antistatic agent is Glycolube AFA-1.

23. A method according to any one of claims 20 to 22, wherein said composition includes from 0.1% to 5% by weight of antistatic agent.

24. A method according to any one of claims 15 to 23, wherein said composition includes a plasticizer.

25. A method according to claim 24, wherein the plasticiser is selected from the group consisting of consisting of triethyl citrate, di-butyl phthalate and dipropylene glycol dibenzoate.

26. A method according to claim 24 or 25, wherein said composition includes from 0.1% to 15% by weight of plasticiser.

27. A method according to any one of claims 15 to 26, wherein said composition includes a dye.

28. A method according to claim 27, wherein the dye is selected from the group consisting of FD&C Blue No. 1, FD&C Red No. 40, FD&C Green No. 3 and FD&C Yellow No. 6.

29. A method according to any one of claims 15 to 28, wherein the composition is applied to the optical substrate by spin coating, dip coating, spray coating and brushing.

30. A method according to any one of claims 15 to 29, wherein the drying occurs at a temperature above the minimum film forming temperature (MFFT) of the applied composition.

31. A removable coating for an optical substrate, the removable coating having been produced according to the method of any one of claims 15 to 30.

32. An optical substrate with a removable coating, the removable coating having been produced according to the method of any one of claims 15 to 30.

33. A composition according to claim 1 substantially as hereinbefore described with reference to any of the Examples.

34. A method according to claim 15 substantially as hereinbefore described with reference to any of the Examples.
